(19) United States
(12) Patent Application Publication
(10) Pub. No.: US 2009/0250439 A1
(43) Pub. Date: Oct. 8, 2009

(54) METHOD OF CREATING A CLAD STRUCTURE UTILIZING A MOVING RESISTANCE ENERGY SOURCE

(76) Inventors: DAVID WORKMAN, Dublin, OH (US); Fabian Orth, Hilliard, OH (US); Timothy Stotler, Columbus, OH (US)

Correspondence Address: GALLAGHER & DAWSEY CO., L.P.A., P.O. BOX 785, COLUMBUS, OH, 43216, US

(21) Appl. No.: 12/412,685

(22) Filed: Mar. 27, 2009

Related U.S. Application Data
(60) Provisional application No. 61/042,836, filed on Apr. 7, 2008.

(51) Int. Cl. B23K 11/00

(52) U.S. Cl. 219/78.02; 219/117.1

(57) ABSTRACT

A method for forming a clad structure utilizing a moving resistance energy source. The method forms a metallurgical bond between a cladding layer and a primary layer such that at least 2% of a cladding layer surface is metallurgically fusion bonded to a primary layer surface. The fusion bond does not extend all the way through the primary layer or the cladding layer. Either, or both, of the layers may incorporate surface texturing to reduce the contact area between the layers, and melting point suppressants may be incorporated into the method.

### CROSS-REFERENCE TO RELATED APPLICATIONS

This application claims the benefit of U.S. provisional patent application Ser. No. 61/042,836, filed on Apr. 7, 2008, all of which is incorporated by reference as if completely written herein.

### STATEMENT REGARDING FEDERALLY SPONSORED RESEARCH OR DEVELOPMENT

This invention was not made as part of a federally sponsored research or development project.

### TECHNICAL FIELD

The present invention relates to materials joining; particularly, to an electrical resistance fusion cladding method.

### BACKGROUND OF THE INVENTION

The field of fusion cladding a primary layer with a cladding layer often results in heat degradation of the primary layer and/or the cladding layer. This is particularly problematic when utilizing a very thin cladding layer. The problem is heightened by the fact that a fusion zone often extends completely through one of the layers, which can expose the fusion zone to deleterious environments. The field has needed a method capable of creating a very thin fusion zone at the interface of the primary layer and the cladding layer, such that the fusion zone does not extend completely through either layer.

### SUMMARY OF THE INVENTION

A method for forming a clad structure utilizing a moving resistance energy source is provided. The method forms a metallurgical bond between a cladding layer and a primary layer such that at least 2% of a cladding layer surface is metallurgically fusion bonded to a primary layer surface. The fusion bond does not extend all the way through the primary layer or the cladding layer. Either, or both, of the layers may incorporate surface texturing to reduce the contact area between the layers, and melting point suppressants may be incorporated into the method.

### BRIEF DESCRIPTION OF THE DRAWINGS

Without limiting the scope of the present invention as claimed below and referring now to the drawings and figures:

FIG. 1 shows an exploded perspective illustration of an assembly;

FIG. 2 shows an assembled perspective illustration of the assembly according to FIG. 1;

FIG. 3 shows a section drawing taken along reference line 3-3 of FIG. 2;

FIG. 4 shows a section drawing taken along reference line 4-4 of FIG. 2;

FIG. 4a shows the assembly of FIG. 4 after bonding to form an internally clad pipe;

FIG. 5 shows a cross section of an assembly according to FIG. 1;

FIG. 6 shows a cross section of an assembly according to FIG. 1, schematically showing force being applied to one point;

FIG. 7 shows a cross section of an assembly according to FIG. 1, schematically showing force being applied from one point, said force being resisted from an external primary layer surface;

FIG. 8 shows a cross section of an assembly according to FIG. 1, schematically showing force being applied to opposite points;

FIG. 9 shows a partial cross section of an assembly according to FIG. 1, showing bonding in progress;

FIG. 10 shows a partial cross section of another assembly according to FIG. 1, showing bonding in progress;

FIG. 11 shows an embodiment having opposing moveable energy sources;

FIG. 12 shows an embodiment having a melting point suppressant between a liner and a pipe;

FIG. 13 shows an exploded perspective illustration of an assembly having an external cladding layer;

FIG. 14 shows a perspective illustration of an assembly having an external cladding layer;

FIG. 15 shows a partial cross section of a sheet cladding assembly; and

FIG. 16 shows a partial cross section of a sheet cladding assembly incorporating a consumable resistance enhancer.

These drawings are provided to assist in the understanding of the exemplary embodiments of the invention as described in more detail below and should not be construed as unduly limiting the invention. In particular, the relative spacing, positioning, sizing and dimensions of the various elements illustrated in the drawings are not drawn to scale and may have been exaggerated, reduced or otherwise modified for the purpose of improved clarity. Those of ordinary skill in the art will also appreciate that a range of alternative configurations have been omitted simply to improve the clarity and reduce the number of drawings.

### DETAILED DESCRIPTION OF THE INVENTION

The claimed invention includes a method of creating a clad structure utilizing a moving resistance energy source. The method enables a significant advance in the state of the art. The preferred embodiments of the method accomplish this resistance cladding by new and novel methods that are configured in unique and novel ways and which demonstrate previously unavailable but preferred and desirable capabilities. The description set forth below in connection with the drawings is intended merely as a description of the embodiments of the claimed method, and is not intended to represent the only form in which the present method may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention.

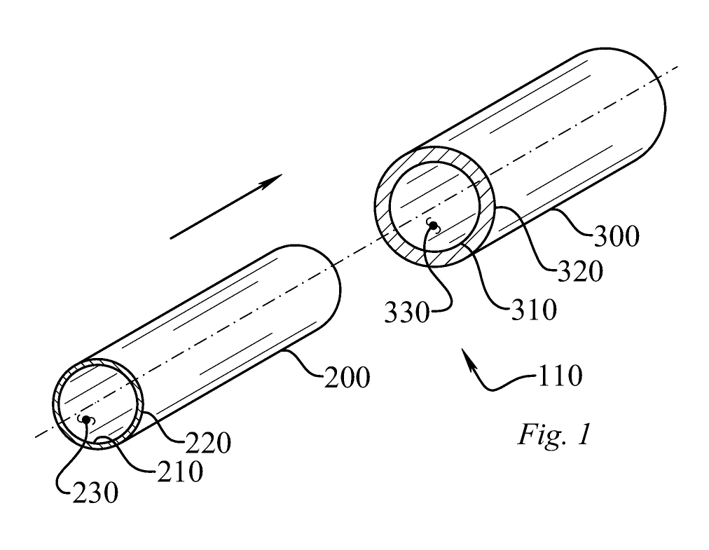

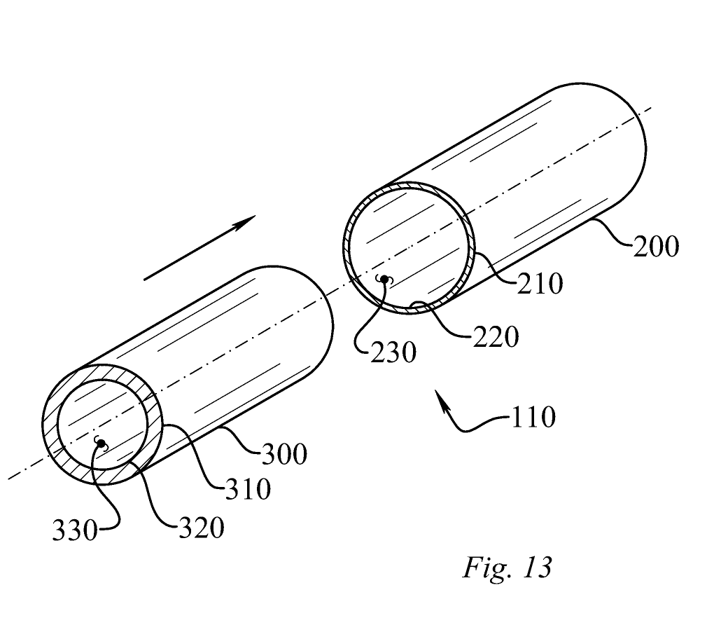

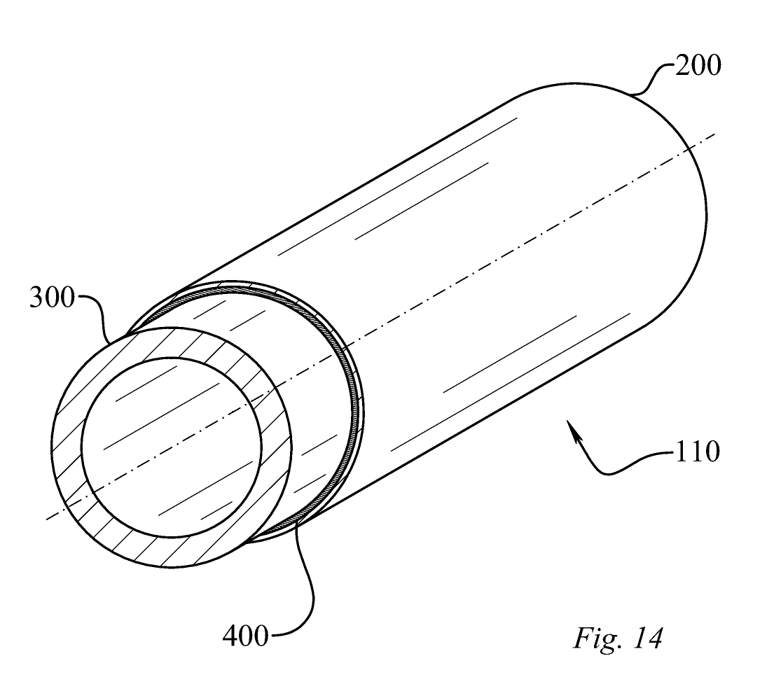

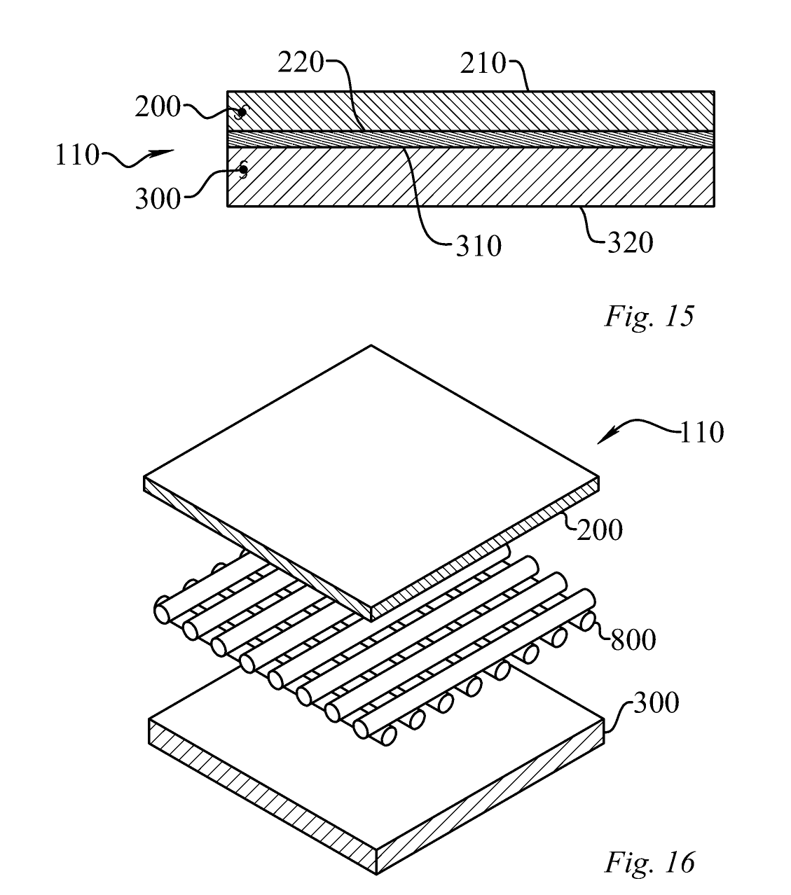

The clad structure (100) and a method for forming the same of the present invention enables, among other features, a clad structure (100) and an assembly (110) having markedly different characteristics on the internal and external aspects of the clad structure (100). Referring now in general to FIGS. 1-17, a method for forming a clad structure (100) may include the steps of first placing a cladding layer (200), having an external cladding layer surface (220), and an internal cladding layer surface (210), on a primary layer (300) to form an assembly (110), prior to bonding. The method may be utilized in cladding structures of any shape including, but not limited to, internally clad pipe as seen in FIGS. 1-12, externally clad pipe as seen in FIGS. 13-14, clad sheet as seen in FIGS. 15-16, and structural members, including the repair of such shapes. The initial description of the method will reference FIGS. 1-12 which illustrate application of the method in forming a clad structure (100) that is a pipe or conduit assembly, however one skilled in the art will recognize that the disclosure applies equally to the cladding of a primary layer (300) of any shape that is suitable for electrical resistance fusion cladding as set forth herein.

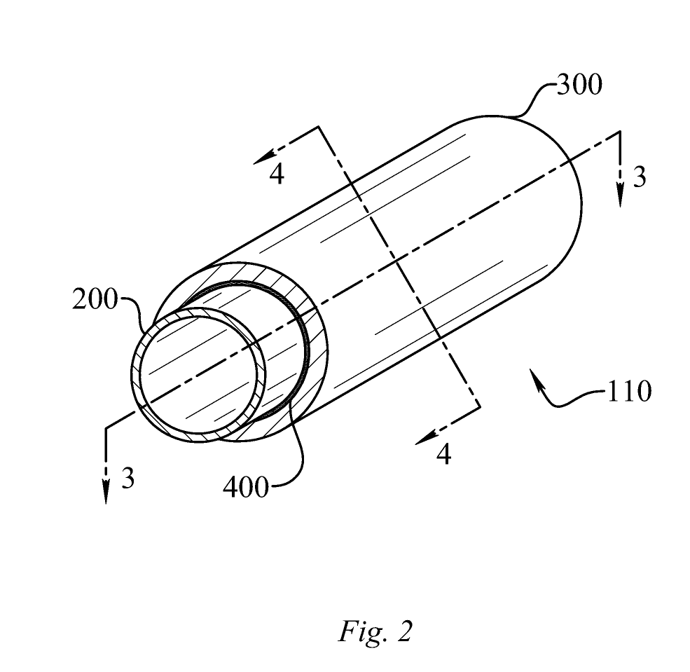

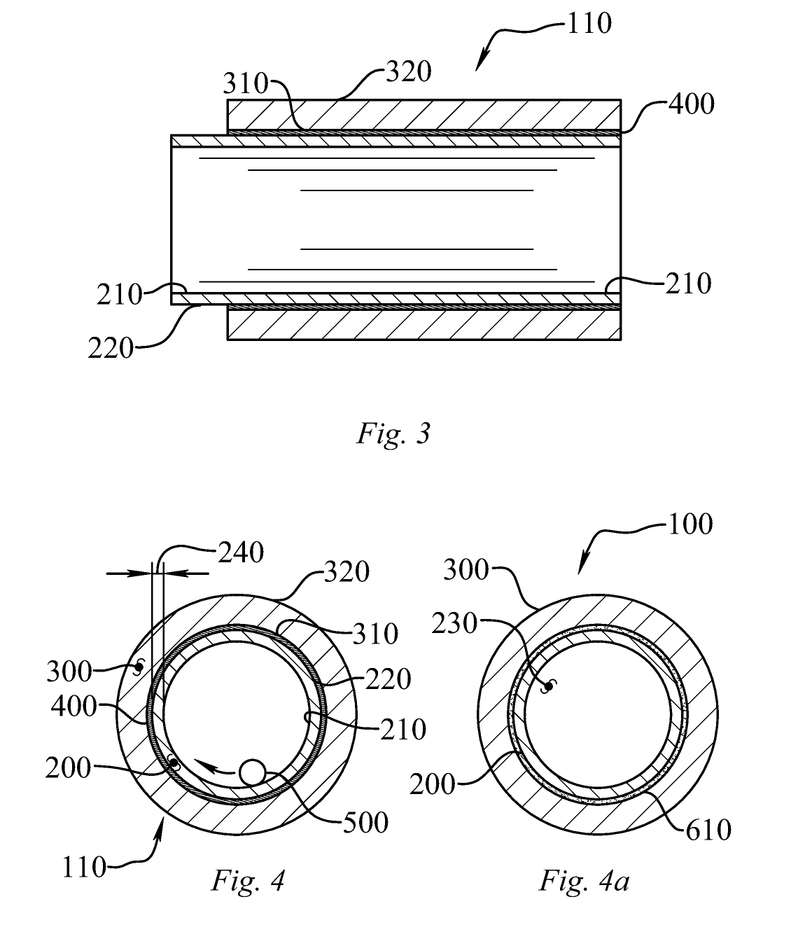

The primary layer (300) may have an external primary layer surface (320), and an internal primary layer surface (310), as seen in FIG. 1. In the particular application of pipe cladding, the internal primary layer surface (310) defines a pipe lumen (330). A joining space (400) of variable thickness remains between the cladding layer (200) and the primary layer (300), seen in FIGS. 2 and 3, after the assembly (110) is formed. One skilled in the art will realize that while a wide variety of materials may be placed in the joining space (400), to serve as a joining compound (420), either before or after assembly, to facilitate the formation of a metallurgical bond (610); such joining compounds (420) may be neither necessary nor desirable in some embodiments.

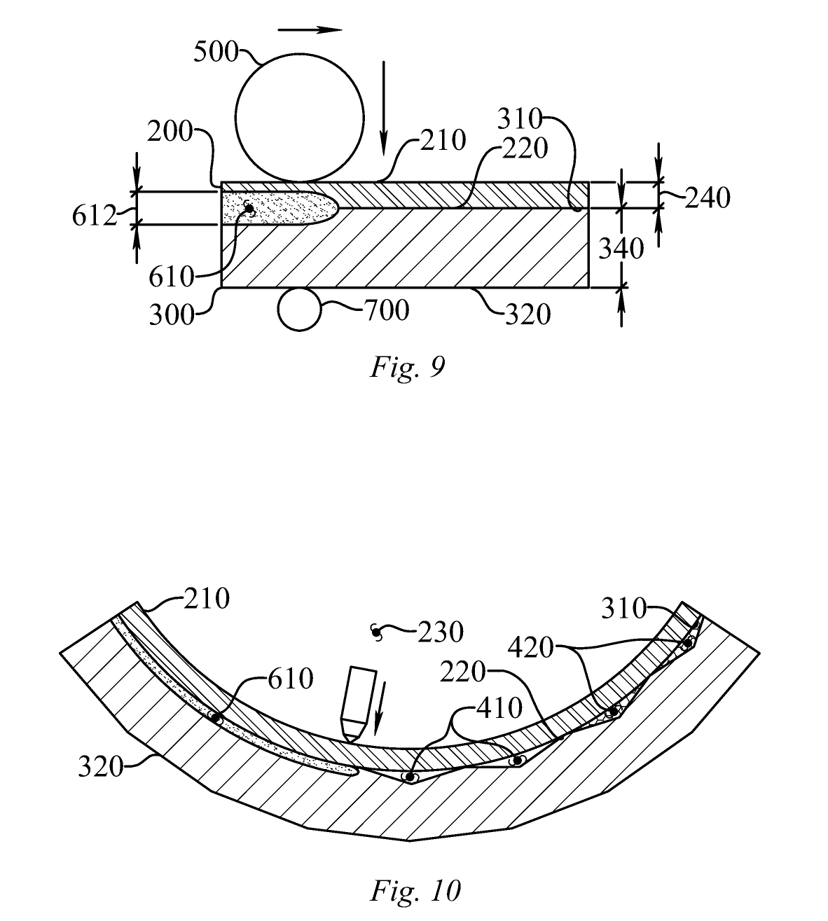

Next, as seen in FIGS. 4, 6-8 (schematic), and 9-12, a movable energy source (500) is positioned in contact with the cladding layer (200) and energized, thereby applying energy to the assembly (110). A predetermined energy input is thus generated, and creates a weld zone (600) encompassing at least a portion of the external cladding layer surface (220) and a portion of the internal primary layer surface (310), as seen in FIGS. 9, 10, and 12. Among other advantages, the method allows heat to develop at the interface of at least a portion of the external cladding layer surface (220) and at least a portion of the internal primary layer surface (310). Since heat developed at this interface need not first pass through either the cladding layer (200) or the primary layer (300); heat degradation of those structures, and in particular of a corrosion resistant alloy cladding layer (200), can be minimized. The method continues by moving the moveable energy source (500) relative to the assembly (110), as indicated in FIGS. 4, 9, 10 and 12. As the moveable energy source (500) moves relative to the assembly (110), and this movement can equally well be accomplished by motion of the energy source (500), the assembly (110), or both (500, 110), relative to one another, a predetermined energy input is achieved. This creates a metallurgical bond (610), seen well in FIGS. 9, 10 and 12, encompassing at least a portion of the external cladding layer surface (220) and a portion of the internal primary layer surface (310). When completed, the method yields a clad structure (100) having a cladding layer (200) and a primary layer (300), wherein any materials in contact with the internal cladding layer surface (210) do not contact either the metallurgical bond (610) or any portion of the primary layer (300), as seen in FIG. 4a.

As noted, the method enables, among other features, a clad structure (100) and assembly (110) having markedly different characteristics on its internal and external aspects. By way of example only, in some embodiments, the cladding layer (200) is formed of a corrosion resistant alloy, which may be, in some embodiments, stainless steel or an austenitic nickel-based alloy (INCONEL™; Special Metals Corporation, New Hartford, N.Y., U.S.A.). Other embodiments may incorporate high carbon steels. Again by way of example only, the use of a corrosion resistant cladding layer (200) may free a designer to consider primary layer (300) compositions in which corrosion resistance is not a factor, as any contents of the clad structure (100) would be contained within the liner lumen (230).

One skilled in the art will perceive that a wide variety of energy sources are suitable for use, in different applications, as the moveable energy source (500). In some embodiments, the moveable energy source (500) is a resistance welding moveable energy source that results in the generation of heat at the interface between the cladding layer (200) and the primary layer (300) by passing current through the layers (200, 300); alternative embodiments incorporate moveable energy sources (500) that generate heat from within the liner lumen (230), sometimes in contact with the cladding layer (200) and in other embodiments not contacting the cladding layer (200), resulting in fusion of a portion of the cladding layer (200) and a portion of the primary layer (300). Such embodiments often incorporate melting point suppressants (430), as will be explained in more detail later herein. Again by way of example only, in certain embodiments, the moveable energy source (500) may be electrical resistance electrodes including roller electrodes, an electrical resistance heater (520), or an induction coil (530).

In other embodiments, the moveable energy source (500) is a high power ultrasonic energy source (510) that creates an ultrasonic weld between a portion of the cladding layer (200) and the primary layer (300). Many types of metallurgical bonds are contemplated by the instant invention, including by way of example only; fusion welds and solid state welds. Those skilled in the metallurgical arts will recognize particular types of metallurgical bonding suitable for use, such as resistance seam welding (RSEW) and ultrasonic joining, and only a few are specifically enumerated in this disclosure even though all may be appropriate for certain applications.

As noted, the moveable energy source (500) moves with relative motion to the assembly (110), and this movement can equally well be accomplished by motion of the energy source (500), the assembly (110), or both (500, 110), relative to one another. In some pipe cladding embodiments, the movable energy source (500) moves relative to the assembly (110) at a velocity of at least 1 foot per minute, allowing for high speed bonding. One particular example incorporates a 0.5 inch wide resistance welding roller electrode having a coverage area that is approximately 0.375 inch to 0.450 inch wide traveling at 12 inches per minute thereby bonding 4.5 to 5.4 square inches per minute. By way of example, a Resistance Seam Electrical Welding moveable energy source (500) could move helically within the liner lumen (230), on the internal liner surface (210), or externally on the external primary layer surface (320), while advancing in a longitudinal direction. Depending on the helical speed, the width of the moveable energy source (500), and the longitudinal speed of motion, varying bonding speeds are attained. Also, as would be understood by one skilled in the art, the relative thicknesses of the cladding layer (200) and the primary layer (300), and the relative thickness of the metallurgical bond (610) may vary considerably depending on the desired metallurgical bond. This helical technique creates at least one weld every 1″-2″ longitudinally down the liner lumen (230), thus ensuring at least 2% of the external cladding layer surface (220) is metallurgically fusion bonded to the internal primary layer surface (310). However, the same method may be used to create one weld right next to the previous weld as the moveable energy source (500) spirals down the liner lumen (230), thus ensuring at least 95% of the external cladding layer surface (220) is metallurgically fusion bonded to the internal primary layer surface (310).

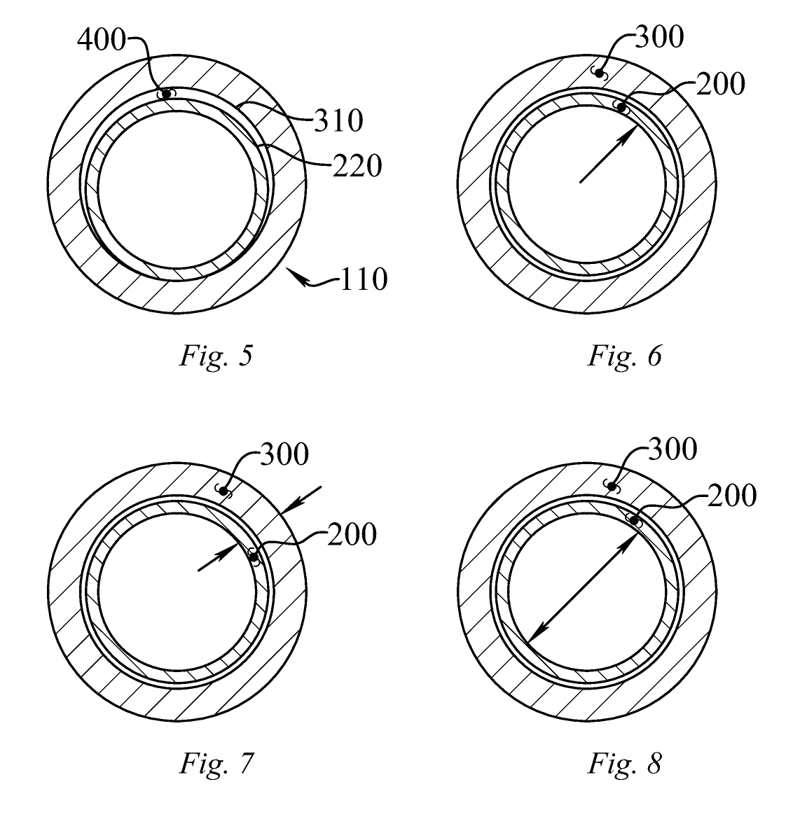

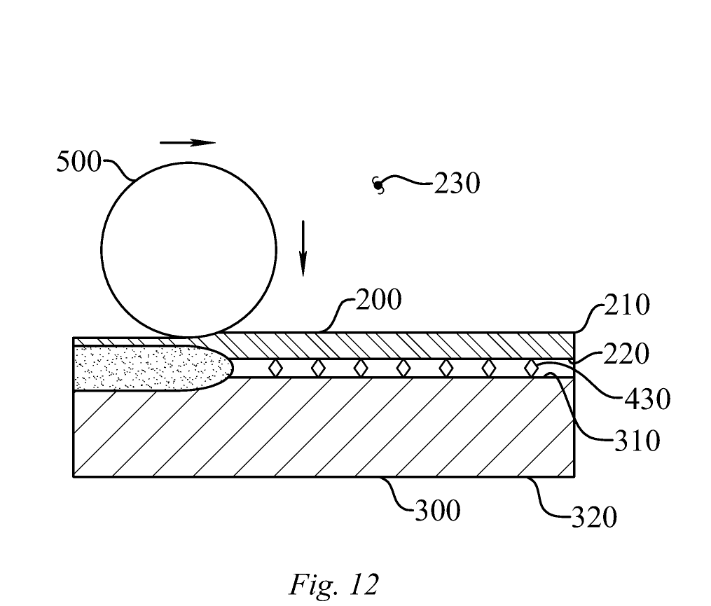

In one embodiment, the cladding layer (200) has a thickness of between one and three millimeters, and in another, the metallurgical bond (610) has a thickness of between 0.13 and 0.50 millimeters. As will be described below in explicating the clad structure (100) made by the instant method, it is equally possible to have a relatively thin cladding layer (200) and a relatively thick primary layer (300) or vice versa; and it is equally possible to have a relatively thin metallurgical bond (610) or a relatively thick metallurgical bond (610), depending on the performance parameters desired. In one particular embodiment, intended by way of example only and not limitation, a joined area of approximately two square inches, required a welding current of 220 kA, with a weld time of 12 cycles and a weld force of 5000 pounds. In such embodiment, the primary layer (300) used was 0.200 inches thick and the liner was 0.060 inches thick. The method proceeds with the step of applying pressure to the internal liner surface (210), thereby pressing the cladding layer (200) against the internal primary layer surface (310), as seen in FIGS. 6-8 (schematic), and FIG. 12. As seen in FIG. 5, placing the cladding layer (200) within the primary layer (300) creates at least a potential joining space (400) between the cladding layer (200) and the primary layer (300). The size of this joining space (400) varies between a relatively tight fit, and one, such as that shown exaggerated in size, in FIG. 5.

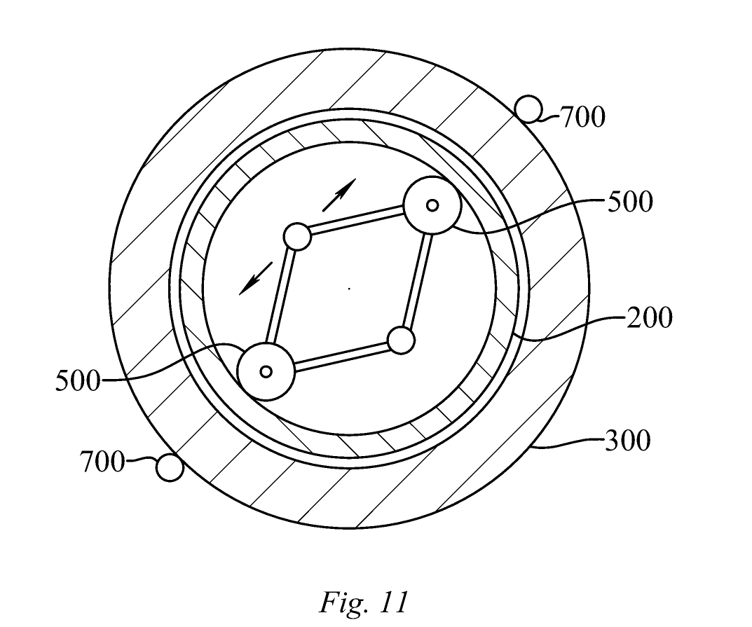

The joining space (400) is not typically absolutely uniform. For example, even with a cladding layer (200) and primary layer (300) that appear to be a close fit, manufacturing irregularities are likely to produce joining space irregularities (410), such as seen in an exaggerated representation in FIG. 10, where the cladding layer (200) and primary layer (300) are less closely approximately in certain places than in others, as would also be produced in the cladding layer (200) and primary layer (300) were out of round or otherwise not congruently shaped. In one embodiment, such joining irregularities (410) may be partially or completely filled by a joining compound (420) also seen in an exaggerated representation in FIG. 10. In other embodiments, the relative plasticity of the cladding layer (200) may allow it to be forced into any joining irregularities (410) thus tending to fill such irregularities and enhance the bond formed between cladding layer (200) and primary layer (300).

Various methods may be used to force the cladding layer (200) against the internal primary layer surface (310). For example, and shown schematically in FIGS. 6-8, pressure may be exerted from the liner lumen (230) towards the primary layer (300). As one skilled in the art would recognize, such a compressive mode would tend to perform best when the cladding layer (200) is relatively thin and pliable compared to the characteristics of the primary layer (300). In various embodiments, it is important for satisfactory performance characteristics of the clad pipe (100) that pressure or energy applied to the cladding layer (200) not be allowed to plastically deform or alter the microstructural characteristics of the primary layer (300).

As seen in FIG. 7 (schematic), pressure applied from within the liner lumen (230) may be opposed by an external structure or structures, such as that provided by one or more mandrels (700) seen in FIGS. 9 and 11. Also, as seen in FIG. 8 (schematic) and in FIG. 11, multiple energy sources (500), or other components within the liner lumen (230) may be opposed so that pressure against one point on the internal piper surface (320) is balanced by pressure on another point of the internal primary layer surface (320). It is to be noted that external mandrels (700), such as seen in FIG. 11, may or may not be necessary or desirable, depending on the characteristics of the specific cladding layer (200) and primary layer (300) being bonded.

Pressure may be generated mechanically, magnetically, and hydraulically in certain embodiments, and one skilled in the art will see that virtually any means of applying pressure may be configured; including embodiments wherein the pressure generated mechanically or magnetically is applied by the moveable energy source (500). In one particular embodiment, hydroforming is used to conform the cladding layer (200) to the primary layer (300), thus minimizing the effect of any joining space irregularities (410) Formation of the metallurgical bond (610) may be facilitated in a number of ways. By way of example only, some embodiments include a step of applying an external cladding layer surface texturing treatment (222) to the external cladding layer surface (220); or a step of applying an internal primary layer surface texturing treatment (312) to the internal primary layer surface (310); or both. In one particular embodiment, the surface texture treatment is applied the layer (200, 300) that is the least electrically resistive material. In the embodiments incorporating corrosion resistant alloys for the cladding layer (200), the primary layer (300) is most commonly the least electrically resistive material and therefore the primary layer (300) incorporates the surface texture treatment. The surface texture treatments (222, 312) tend to concentrate energy at the surfaces so treated, particularly during resistance welding. Surface texture treatments may be applied to the external cladding layer surface (220) and the internal primary layer surface (310). By way of example and not limitation, it has been found that an external cladding layer surface texturing treatment (222) including surface striations of 90 degrees, and varying in surface relief of between 0.003 and 0.015 inches, produced an excellent quality weld without the need for any special electrode geometries.

As one skilled the art would recognize, surface roughness is the measure of the surface irregularities in the surface texture. Surface roughness Ra is rated as the arithmetic average deviation of the surface valleys and peaks expressed in microinches or micrometers. All Ra references herein are in microinches. In the embodiments that incorporate a surface texturing treatment (222, 312), the treatment preferably results in a surface roughness Ra of at least 250 microinches. In yet another embodiment the surface texturing treatment (222, 312) reduces the surface contact area by at least 30% over the contact area of the interface between the internal primary layer surface (320) and the external cladding layer surface (220). One skilled in the art will recognize the various surface finishing techniques that may be used to achieve the surface texturing, including, but not limited to, mechanical polishing with various grit finishes, blasting such as sand, glass, and bead, etching, electropolish, snagging, sawing, planing, drilling, milling, electron beam finishing, laser beam finishing, boring, turning, grinding, embossing, and burnishing, just to name a few.

Another embodiment incorporates a step of placing a consumable resistance enhancer (800) between the cladding layer (200) and the primary layer (300), as seen in FIG. 16. The consumable resistance enhancer (800) increases the electrical resistance, and reduces a contact area, at the interface between the cladding layer (200) and the primary layer (300). At least 2% of the consumable resistance enhancer (800) is consumed within the fusion weld zone, however embodiments creating a 95% metallurgical fusion bond consume at least 95% of the consumable resistance enhancer (800) in the fusion weld zone. The consumable resistance enhancer (800) may be applied in a number of forms including, but not limited to, powder, screen, mesh, and foil.

Similarly, some embodiments, and as seen in FIG. 12, include a step of applying a melting point suppressant (430) between the cladding layer (200) and the primary layer (300). This may be accomplished by applying a melting point suppressant (430) to the cladding layer (200) or the primary layer (300) to a thickness of less than 5 microns. Such a melting point suppressant (430) may include boron, nickel, or other compounds well known in the art. The step of applying a melting point suppressant (430) between the cladding layer (200) and the primary layer (300) will decrease the energy input required to create the weld zone by at least 20% in some embodiments, or by as much as 80% in other embodiments. One skilled in the art will see that if the melting point of the material at the interface of the external cladding layer surface (220) and the internal primary layer surface (310) is sufficiently depressed, by way of example only, it is possible to create a weld zone (600), and hence a metallurgical bond (610), at such interface while the internal cladding layer surface (210) and/or external primary layer surface (320) remain solid. In another embodiment, provided by way of example only, successful welds were made with striations varying in height between 0.015 and 0.007 inches, and including a melting point suppressant layer (430) including a 0.0003 inch thick layer (total) of Nickel, Chromium, and Boron. In yet another embodiment the melting point suppressant (430) may be included in a consumable resistance enhancer (800). Alternatively, in another embodiment, the melting point suppressant (430) is introduced in the form of a film or thin sheet. As with the consumable resistance enhancer (800), at least 2% of the melting point suppressant layer (430) is consumed within the fusion weld zone, and it increases proportional to the percentage of the metallurgical fusion bond formed between the external cladding layer surface (220) and the internal primary layer surface (310).

As a general principal of materials joining, interlayers such as melting point suppressants function optimally if the thickness of such interlayers is minimized. In one particular embodiment of the instant invention, intended by way of example only, an interlayer thickness of 0.001 inch produced a successful weld, but one that had a larger than desired heat affected zone. Further embodiments, also by way of example only, using an interlayer thickness of 0.003 inches, produced a minimal heat affected zone. It was observed that the fusion zone width, in embodiments utilizing interlayers, is dictated by the available alloy addition in the interlayer. Melting point suppression declines as a result of the mixing of the interlayer, cladding layer (200) and primary layer (300) materials, as the melting of a portion of the cladding layer (200) and primary layer (300) tends to dilute the concentration of the suppressant provided in the melting point suppressant layer (430); and as a result, this results in a halting of the progression of the growth of the weld zone. It various embodiments, again intended by way of example only, once the fusion zone was found to extend to beyond about 70% of the interlayer thickness, dilution of the alloy resulted in stoppage of weld zone growth, followed by isothermal solidification.

One particular embodiment, intended by way of example only and not limitation, and shown well in FIG. 12, illustrates a means in which the melting point suppressant (430) is used to increase the electrical resistance of the assembly (110), particularly at the point of application of the melting point suppressant (430). In this embodiment, pieces of conductive melting point suppressant (430) are positioned in the joining space (400) between the external cladding layer surface (220) and the internal primary layer surface (310). If opposite electrical currents are applied to the cladding layer (200) and the primary layer (300), electricity will preferentially flow at the points of the cladding layer (200) and primary layer (300) connected by the pieces of conductive melting point suppressant (430). These may serve as melting foci, facilitating the formation of the weld zone (600), and hence the metallurgical bond (610), along the interface between the cladding layer (200) and the primary layer (300).

In one embodiment, a clad structure(100) is produced, with a cladding layer (200) having a cladding layer thickness (240); a primary layer (300) having a primary layer thickness (340); and a metallurgical bond (610) between the cladding layer (200) and the primary layer (300), as seen in FIG. 4a. In contrast to certain prior art clad pipe where welds made from the internal cladding layer surface (210) or from the external primary layer surface (320) produce a weld zone (600) extending through the full cladding layer thickness (240) or the full primary layer thickness (340); the metallurgical bond (610) of the present method has a metallurgical bond thickness (612) less than the cladding layer thickness (240) and less than the pipe thickness (340), thus leaving the internal cladding layer surface (210) and the external primary layer surface (320) unchanged.

One skilled in the art will immediately see that this allows at least a portion of the cladding layer (200), and in particular the internal liner surface (210), to not be affected in composition by the weld zone (600) or the metallurgical bond (610). By way of example only, should an clad structure (100) be formed with a stainless steel cladding layer (200) and a steel primary layer (300); the inner liner surface (210) will not be mixed with steel from the primary layer (300) as the weld zone (600) does not extend full thickness through either the cladding layer (200) or the primary layer (300). Thus, since any contents of the clad structure (100) would be contained within the liner lumen (230), one skilled in the art may freely design cladding layer (200) compositions suited to particular applications, with diminished concerns for possible mixing of materials between the cladding layer (200) and primary layer (300), and without necessarily compromising desired characteristics of the primary layer (300).

In various embodiments, the metallurgical bond thickness (612) is less than about 90% of the cladding layer thickness (240), and in other embodiments, the metallurgical bond thickness (612) may range downwards to less than about 10% of the cladding layer thickness (240). Similarly, in some embodiments, the metallurgical bond thickness (612) is less than about 90% of the primary layer thickness (340), while in other embodiments; the metallurgical bond thickness (612) may range downwards to less than about 10% of the primary layer thickness (340). Thus, it will be seen by one skilled in the art that with variations of cladding layer thickness (240), primary layer thickness (340), joining techniques, a near infinite set of relative proportions may be formed between the cladding layer thickness (240), primary layer thickness (340), and metallurgical bond thickness (612). Therefore, consistent with the above, in one particular embodiment, the metallurgical bond thickness (612) is less that 10% of the total thickness of either the cladding layer (200) or the primary layer (300). In further successful embodiments, intended by way of example only, the metallurgical bond thickness (612) ranged between 0.1% and 5%, of the thickness of the thinnest of the layers including the cladding layer (200) and the primary layer (300).

The benefits of such a thin metallurgical bond thickness (612), one that does not extend to the opposite surface of either the cladding layer (200) or the primary layer (300), are apparent to one skilled in the art. In one particular embodiment, intended by way of example only, a total weld bond was produced on the order of 0.002 inches thick, and in which a clear fusion zone could be observed. In this embodiment, the heat affected zone on each side of such fusion area displayed penetration of a melting point suppressant layer of approximately 0.0 10 inches into both the primary layer (300) and cladding layer (200).

Similarly, it is possible to vary the total amount of internal inner surface (220) which is metallurgically bonded to the internal primary layer surface (310), such as, by way of example, making multiple passes of the moveable energy source (500) very close to one another, in a longitudinal direction; or by making a series of spot welds, as opposed to a continuous welding pattern. In some embodiments, the metallurgical bond (610) bonds at least 2% of the external cladding layer surface (220) to the internal primary layer surface (310), while in others, the metallurgical bond (610) bonds at least 80% of the external cladding layer surface (220) to the internal primary layer surface (310), however it is preferable when using an electrical resistance heat source to produce a metallurgical fusion bond in which at least 95% of the external cladding layer surface (220) is joined to the internal primary layer surface (310).

The method for forming a clad structure (100) utilizing a moving resistance energy source may be used with cladding layers (200) composed of the following materials, including, but not limited to, Inconel, Nickel Based Corrosion Resistant Alloy, Incoloy, Iron Based Corrosion Resistant Alloy, Cobalt Based Corrosion Resistant Alloy, High Temperature Alloy, and Stainless Steel. Applications for the clad structures (100) produced by the method include, but are not limited to, pipelines, tubulars, risers, flowlines, exhaust gas systems, boiler tubes, heat exchangers, distillation processing facilities, chemical distillation systems, chemical fractionation systems often referred to as “fracking” systems.

Numerous alterations, modifications, and variations of the preferred embodiments disclosed herein will be apparent to those skilled in the art and they are all anticipated and contemplated to be within the spirit and scope of the instant invention. For example, although specific embodiments have been described in detail, those with skill in the art will understand that the preceding embodiments and variations can be modified to incorporate various types of substitute and or additional or alternative manufacturing processes and materials, relative arrangement of elements, and dimensional configurations. Accordingly, even though only few variations of the present invention are described herein, it is to be understood that the practice of such additional modifications and variations and the equivalents thereof, are within the spirit and scope of the invention as defined in the following claims. The corresponding structures, materials, acts, and equivalents of all means or step plus function elements in the claims below are intended to include any structure, material, or acts for performing the functions in combination with other claimed elements as specifically claimed.

We claim:

1. A method for forming a clad structure (100) utilizing a moving resistance energy source comprising the steps of:
a. placing a cladding layer (200), having an external cladding layer surface (220) and an internal cladding layer surface (210), adjacent to a primary layer (300), having an external primary layer surface (320) and an internal primary layer surface (310), to form an assembly (110);
b. positioning a movable energy source (500) in contact with the cladding layer (200) and the primary layer (300);
c. energizing the movable energy source (500) to apply energy to the assembly (110), generating a predetermined energy input, and creating a fusion weld zone (600) encompassing at least a portion of the external cladding layer surface (220) and a portion of the internal primary layer surface (310) and wherein the weld zone does not extend to the internal cladding layer surface (210) or the external primary layer surface (320), wherein the moveable energy source (500) is an electrical resistance heat source resulting in fusion of a portion of the cladding layer (200) and a portion of the primary layer (300);
d. moving the moveable energy source (500) relative to the assembly (110); and
e. forming a metallurgical bond (610) between the cladding layer (200) and the primary layer (300) such that at least 2% of the external cladding layer surface (220) is metallurgically fusion bonded to the internal primary layer surface (310).

2. The method according to claim 1, wherein at least 95% of the external cladding layer surface (220) is metallurgically fusion bonded to the internal primary layer surface (310).

3. The method according to claim 1, wherein the cladding layer (200) is formed of a corrosion resistant alloy.

4. The method according to claim 3, wherein the corrosion resistant alloy is stainless steel.

5. The method according to claim 3, wherein the corrosion resistant alloy is an austenitic nickel-based alloy.

6. The method according to claim 1, wherein the movable energy source (500) moves relative to the assembly (110) and bonds at least 4.5 square inches per minute.

7. The method according to claim 1, wherein the cladding layer (200) has a thickness of less than three millimeters.

8. The method according to claim 1, wherein the metallurgical bond (610) has a metallurgical bond thickness (612) of less than 0.50 millimeters.

9. The method according to claim 1, further comprising the step of applying pressure to the assembly (110), thereby pressing the cladding layer (200) against the internal primary layer surface (310).

10. The method according to claim 9, wherein the pressure is generated mechanically and applied by the moveable energy source (500).

11. The method according to claim 1, further comprising a step of applying an external cladding layer surface texturing treatment (222) to the external cladding layer surface (220).

12. The method according to claim 11, wherein the external cladding layer surface texturing treatment (222) produces a surface roughness Ra of at least 250 microinches on the external cladding layer surface (220).

13. The method according to claim 1, further comprising a step of applying an internal primary layer surface texturing treatment (312) to the internal primary layer surface (310).

14. The method according to claim 13, wherein the internal primary layer surface texturing treatment (312) produces a surface roughness Ra of at least 250 microinches on the internal primary layer surface (310).

15. The method according to claim 1, further comprising a step of placing a consumable resistance enhancer (800) between the cladding layer (200) and the primary layer (300), wherein the consumable resistance enhancer (800) increases the electrical resistance, and reduces a contact area, at the interface between the cladding layer (200) and the primary layer (300), and wherein at least 95% of the consumable resistance enhancer (800) is consumed within the fusion weld zone.

16. The method according to claim 15, wherein the consumable resistance enhancer (800) is in screen form.

17. The method according to claim 15, wherein the consumable resistance enhancer (800) includes a melting point suppressant (430).

18. The method according to claim 1, further comprising a step of applying a melting point suppressant (430) between the cladding layer (200) and the primary layer (300).

19. The method according to claim 18, wherein the step of applying a melting point suppressant (430) further comprises the step of chemically applying the melting point suppressant (430) to the external cladding layer surface (220) to a thickness of less than 5 microns.

20. The method according to claim 18, wherein the melting point suppressant (430) includes boron.

21. The method according to claim 18, wherein the melting point suppressant (430) includes nickel.

22. The method according to claim 18, wherein the step of applying a melting point suppressant (430) between the cladding layer (200) and the primary layer (300) decreases the energy input required to create the weld zone by at least 20%.

23. A method for forming a clad structure (100) utilizing a moving resistance energy source comprising the steps of:
a. placing a cladding layer (200), having an external cladding layer surface (220) and an internal cladding layer surface (210), thereby defining a cladding layer thickness (240), adjacent to a primary layer (300), having an external primary layer surface (320) and an internal primary layer surface (310), thereby defining a primary layer thickness (340), to form an assembly (110), wherein the least electrically resistive layer selected from the cladding layer (200) and primary layer (300) has a surface roughness Ra of at least 250 microinches, and wherein the cladding layer (200) has a thickness of less than three millimeters;
b. positioning a movable energy source (500) in contact with the cladding layer (200) and the primary layer (300);
c. applying pressure to the assembly (110) via the movable energy source (500), thereby pressing the cladding layer (200) against the internal primary layer surface (310);
d. energizing the movable energy source (500) to apply energy to the assembly (110), generating a predetermined energy input, and creating a fusion weld zone (600) encompassing at least a portion of the external cladding layer surface (220) and a portion of the internal primary layer surface (310) and wherein the weld zone does not extend to the internal cladding layer surface (210) or the external primary layer surface (320), wherein the moveable energy source (500) is an electrical resistance heat source resulting in fusion of a portion of the cladding layer (200) and a portion of the primary layer (300);
e. moving the moveable energy source (500) relative to the assembly (110); and
f. forming a metallurgical bond (610) between the cladding layer (200) and the primary layer (300) such that at least 95% of the external cladding layer surface (220) is metallurgically fusion bonded to the internal primary layer surface (310), and the metallurgical bond (610) has a metallurgical bond thickness (612) of less than 0.50 millimeters and the metallurgical bond thickness (612) is less than 5% of the thickness of the lesser of the cladding layer thickness (240) and the primary layer thickness (340).
